(19) United States
(12) Patent Application Publication
(10) Pub. No.: US 2025/0173503 A1
(43) Pub. Date: May 29, 2025

(54) CALCULATION EXPRESSION SETTING SYSTEM, CALCULATION EXPRESSION SETTING METHOD, AND INFORMATION STORAGE MEDIUM

(71) Applicant: Cybozu, Inc., Tokyo (JP)

(72) Inventors: Naoki TATEYAMA, Tokyo (JP); Yuta SAITO, Saitama-shi (JP)

(21) Appl. No.: 18/959,410

(22) Filed: Nov. 25, 2024

(30) Foreign Application Priority Data
Nov. 27, 2023 (JP) 2023-199651

(51) Int. Cl. G06F 40/18

(52) U.S. Cl. CPC G06F 40/18

(57) ABSTRACT

Provided is a calculation expression setting system including at least one processor, the at least one processor being configured to: display, based on input by a user on a calculation expression setting screen for receiving input of a calculation expression to be set in a database, pieces of other information other than a function as candidates on the calculation expression setting screen; identify a candidate selected by the user; and assist input of the calculation expression based on the identified candidate.

### CROSS-REFERENCE TO RELATED APPLICATION

The present disclosure contains subject matter related to that disclosed in Japanese Patent Application JP 2023-199651 filed in the Japan Patent Office on Nov. 27, 2023, the entire contents of which are hereby incorporated by reference.

### BACKGROUND OF THE INVENTION

### 1. Field of the Invention

The present disclosure relates to a calculation expression setting system, a calculation expression setting method, and an information storage medium.

### 2. Description of the Related Art

Hitherto, there has been known a technology which automatically calculates the value of a field in a database based on a calculation expression input by a user. For example, in “What is the true nature of the function list that appears during input of mathematical expressions?,” Internet, retrieved on Oct. 12, 2023, online, https://forest.watch.impress.co.jp/docs/serial/exceltips/1221327.html), there is described a spreadsheet software which displays functions that match characters input by the user as candidates on a screen which receives the input of calculation expressions set in the database. In the spreadsheet software of “What is the true nature of the function list that appears during input of mathematical expressions?,” a candidate selected by the user is automatically input as a function of the calculation expression.

However, the spreadsheet software of “What is the true nature of the function list that appears during input of mathematical expressions?” can display functions that match characters input by the user as candidates, but this spreadsheet software cannot display other information such as arguments as candidates. The user is required to input other information such as arguments after selecting a function displayed as a candidate, and thus the spreadsheet software of “What is the true nature of the function list that appears during input of mathematical expressions?” is unable to sufficiently increase convenience of the user.

### SUMMARY OF THE INVENTION

One object of the present disclosure is to increase convenience of a user.

According to at least one embodiment of the present disclosure, there is provided a calculation expression setting system including at least one processor, the at least one processor being configured to: display, based on input by a user on a calculation expression setting screen for receiving input of a calculation expression to be set in a database, pieces of other information other than a function as candidates on the calculation expression setting screen; identify a candidate selected by the user; and assist input of the calculation expression based on the identified candidate.

### BRIEF DESCRIPTION OF THE DRAWINGS

FIG. 1 is a diagram for illustrating an example of a hardware configuration of a calculation expression setting system.

FIG. 2 is a view for illustrating an example of an app screen.

FIG. 3 is a view for illustrating an example of a calculation expression setting screen.

FIG. 4 is a view for illustrating an example of a calculation expression setting screen.

FIG. 5 is a view for illustrating an example of a calculation expression setting screen.

FIG. 6 is a diagram for illustrating an example of functions implemented in the calculation expression setting system.

FIG. 7 is a table for showing an example of app setting data.

FIG. 8 is a table for showing an example of function data.

FIG. 9 is a flow chart for illustrating an example of processing executed by the calculation expression setting system.

FIG. 10 is a view for illustrating an example of a calculation expression setting screen displayed when a button indicating insertion of a field code is selected.

FIG. 11 is a table for showing an example of candidate narrowing data.

### DESCRIPTION OF THE EMBODIMENTS

### 1. Hardware Configuration of Calculation Expression Setting System

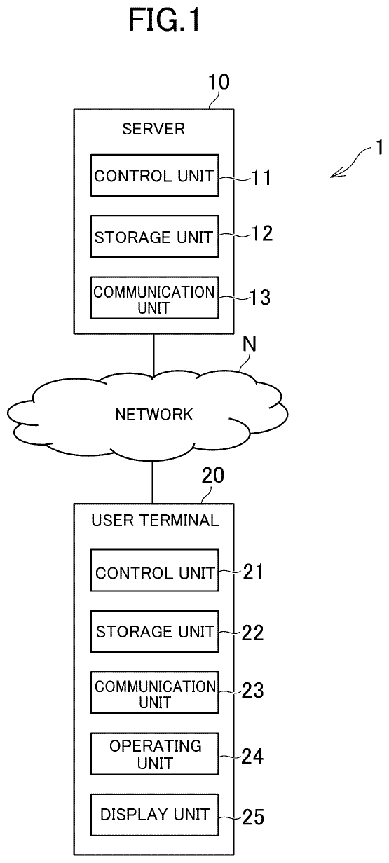

An example of a calculation expression setting system, a calculation expression setting method, and a program according to at least one embodiment of the present disclosure is described. FIG. 1 is a diagram for illustrating an example of a hardware configuration of the calculation expression setting system. For example, a calculation expression setting system 1 includes a server 10 and a user terminal 20. The server 10 and the user terminal 20 are each connected to a network N, such as the Internet or a LAN.

The server 10 is a server computer. For example, the server 10 includes a control unit 11, a storage unit 12, and a communication unit 13. The control unit 11 includes at least one processor. The storage unit 12 includes at least one of a volatile memory such as a RAM, or a non-volatile memory such as a flash memory. The communication unit 13 includes at least one of a communication interface for wired communication or a communication interface for wireless communication.

The user terminal 20 is a computer of a user. For example, the user terminal 20 is a personal computer, a tablet terminal, or a smartphone. The user terminal 20 includes a control unit 21, a storage unit 22, a communication unit 23, an operating unit 24, and a display unit 25. Hardware configurations of the control unit 21, the storage unit 22, and the communication unit 23 may be the same as those of the control unit 11, the storage unit 12, and the communication unit 13, respectively. The operating unit 24 is an input device, such as a mouse or a keyboard. The display unit 25 is a liquid crystal display or an organic EL display.

Programs stored in the storage units 12 and 22 may be supplied to the server 10 and the user terminal 20, respectively, via the network N. Moreover, a hardware configuration of each of the server 10 and the user terminal 20 is not limited to the example of FIG. 1. For example, a reading unit (for example, a memory card slot) which reads an information storage medium or an input/output unit (for example, a USB terminal) which is used to connect to the information storage medium may be included in each of the server 10 and the user terminal 20. In this case, programs stored in the information storage medium may be supplied to each of the server 10 and the user terminal 20 via the reading unit or the input/output unit.

Further, the calculation expression setting system 1 is only required to include at least one computer. The computers included in the calculation expression setting system 1 are not limited to the example of FIG. 1. For example, the calculation expression setting system 1 may include only the server 10. In this case, the user terminal 20 exists outside the calculation expression setting system 1. The calculation expression setting system 1 may include only the user terminal 20. In this case, the server 10 exists outside the calculation expression setting system 1. The calculation expression setting system 1 may include the server 10 and another server computer. The calculation expression setting system 1 may include only other computers other than the server computer.

### 2. Overview of Calculation Expression Setting System

In the at least one embodiment, a case in which the server 10 provides a groupware app to a user is taken as an example. The app includes a database in which various types of data relating to tasks of the user are stored. An app is an example of a database. Thus, in the description given below, the term “app” can be read as “database.” Databases are not limited to apps, as described in modification examples described later.

An app may have other functions in addition to a function as a database. For example, an app may have at least one of a communication tool function or a file management function. When the user logs in to the groupware and selects a given app, the user terminal 20 displays an app screen showing the content of the app on the display unit 25.

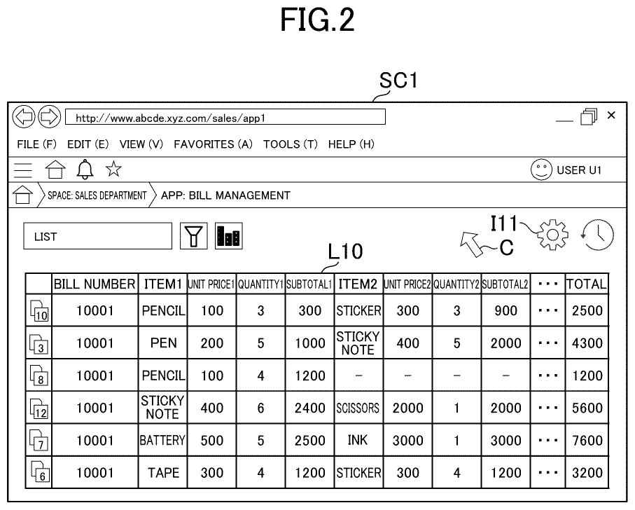

FIG. 2 is a view for illustrating an example of an app screen. In the example of FIG. 2, an app screen SC1 of an app which manages bills is shown. For example, the app screen SC1 includes a record list L10 showing a list of records, which are each a single data unit in the app. The record list L10 shows the values of fields, which are each a single item forming a record. “Field” may also be referred to by another name, such as “cell.” The first row of the record list L10 indicates a field name, which is the name of the field. “Field name” may also be referred to by another name, such as “column name.”

In the at least one embodiment, a field code is provided in addition to the field name in order to identify individual fields. Duplicate field codes are not allowed within the app. The field code is mainly used for reference by groupware programs. Duplicate field names are allowed within the app. The field name is mainly used for display on the user terminal 20. The field name is displayed in the record list L10. The field code is not displayed in the record list L10.

For example, the value of each of a bill number field, an item name field, a unit price field, and a quantity field is input by the user. The value in each subtotal field is calculated by multiplying the value in the unit price field by the value in the quantity field. The value in the total field is the total of the values in the subtotal fields. In the example of FIG. 2, the user has already set calculation expressions for those calculations. The app calculates the values in the subtotal fields and the value in the total field based on the calculation expressions set by the user.

An example of an operation for a user to set a calculation expression is now described. In the following description, the user has not yet set a calculation expression for the app. For example, when the user selects an icon I11 for various settings of the app and then designates a field in which a calculation expression is to be set, the display unit displays a calculation expression setting screen which receives input of the calculation expression. It is assumed here that the user has selected a field indicating a first subtotal. The field code of this field is “syou1,” and the field name of the field is “subtotal 1.”

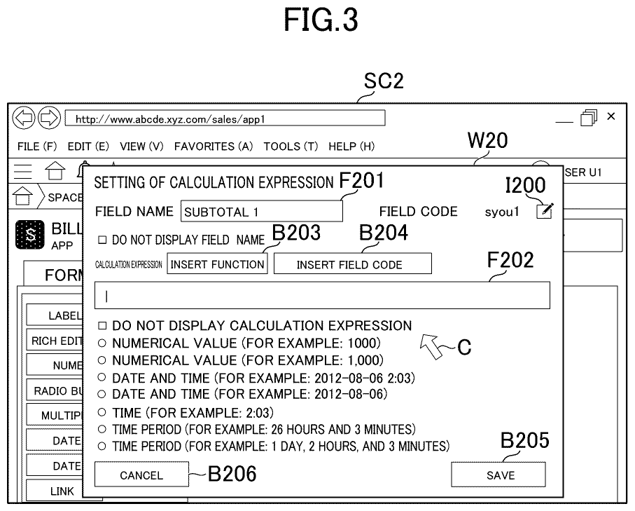

FIG. 3 to FIG. 5 are views for illustrating examples of the calculation expression setting screen. As illustrated in FIG. 3, a calculation expression setting screen SC2 includes a window W20 which receives input by the user. The window W20 shows the field code and the field name of the field selected by the user. For example, the user can change the field code by selecting an icon I200. The user can change the field name based on input to an input form F201. The user can set a calculation expression in the field based on input to an input form F202.

For example, the value of the field indicating the first subtotal is obtained by multiplying the value of the field indicating the first unit price by the value of the field indicating the first quantity. Accordingly, the user inputs to the input form F202 a calculation expression indicating multiplication of the value of the field indicating the first unit price and the value of the field indicating the first quantity. In the at least one embodiment, duplicate field names are allowed, and hence a field may not be uniquely identified by the field name. Thus, in place of the field name, the user inputs the field code as the argument of the calculation expression.

For example, when the field code of the field indicating the first unit price is “tan1,” and the field code of the field indicating the first quantity is “suu1,” in this case, when the user inputs the calculation expression “tan1*suu1” to the input form F202, an appropriate calculation expression can be set in the field indicating the first subtotal. The user may manually set all of the calculation expression, but in the at least one embodiment, the user terminal 20 provides input assistance to the user based on the input to the input form F202.

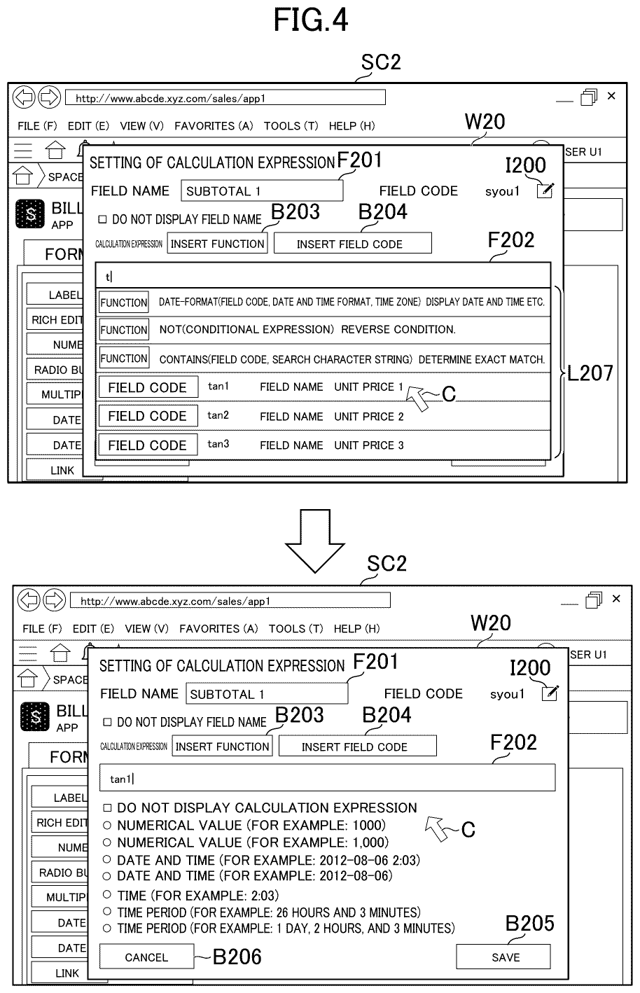

For example, when the user inputs the character “t” to the input form F202, as illustrated in the upper part of FIG. 4, the user terminal 20 searches each function name, each field code, and each field name based on the character “t” input by the user. Here, it is assumed that the function “DATE-FORMAT,” the function “NOT,” the function “CONTAINS,” the field code “tan1,” the field code “tan2,” and the field code “tan3” are found in the search. The user terminal 20 displays a candidate list L207 indicating those as the candidates on the calculation expression setting screen SC2.

For example, when the user selects the field code “tan1” from the candidate list L207, as illustrated in the lower part of FIG. 4, the user terminal 20 inputs the field code “tan1” into the input form F202. Similarly, every time the user inputs something to the input form F202, the user terminal 20 searches for candidates that can be constituent elements of the calculation expression, and displays the results of the search in the candidate list L207.

For example, the user completes the calculation expression “tan1*suu1” while selecting candidates from the candidate list L207 as required. When the user selects a button B205, the setting of the calculation expression is completed. When the user selects a button B206, the setting of the calculation expression is canceled. The processing executed when the user selects buttons B203 and B204 is described in the modification examples described later. The user sets a calculation expression in the same manner for each field of the second subtotal of the bill and the third subtotal of the bill.

For example, the total of the bill is the total value of the plurality of subtotals. Here, when it is assumed that the field code of the field indicating the first subtotal is “syou1,” the field code of the field indicating the second subtotal is “syou2,” the field code of the field indicating the third subtotal is “syou3,” and a function “SUM” is prepared as a function for calculating the total value, for example, when the user inputs the calculation expression “SUM (syou1, syou2, syou3)” to the input form F202, an appropriate calculation expression can be set in the field indicating the total.

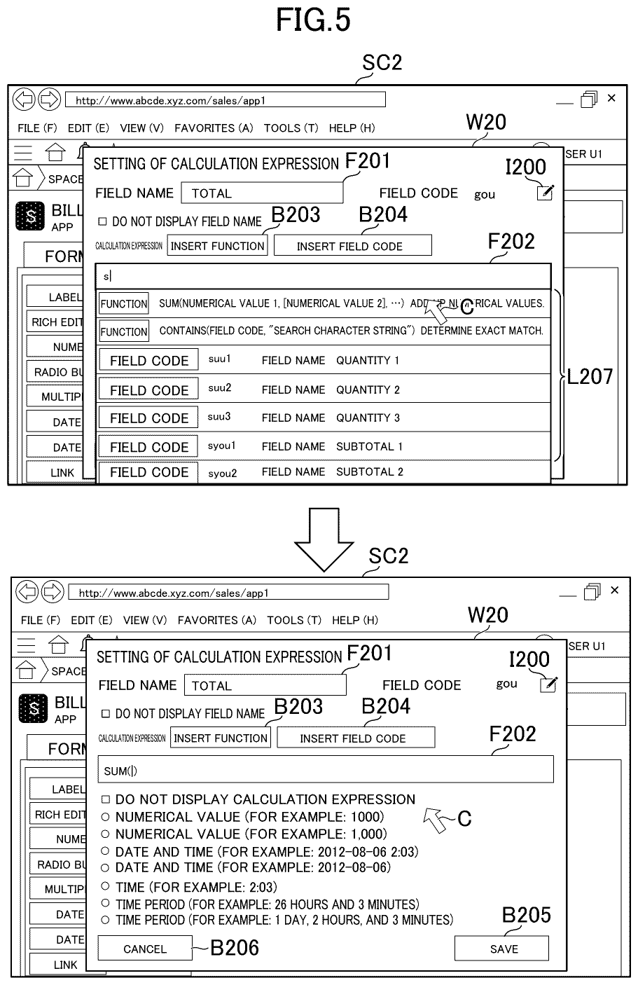

For example, when the user inputs the character “s” to the input form F202, as illustrated in the upper part of FIG. 5, the user terminal 20 searches each function name, each field code, and each field name based on the character “s” input by the user. Here, it is assumed that the function “SUM,” the function “CONTAINS,” the field code “suu1,” the field code “suu2,” the field code “suu3,” the field code “syou1,” the field code “syou2,” and the field code “syou3” are found in the search. The user terminal 20 displays a candidate list L207 indicating those as the candidates on the calculation expression setting screen SC2.

For example, when the user selects the function “SUM” from the candidate list L207, as illustrated in the lower part of FIG. 5, the user terminal 20 inputs the function “SUM” into the input form F202. Similarly, every time the user inputs something to the input form F202, the user terminal 20 searches for candidates that can be constituent elements of the calculation expression, and displays the results of the search in the candidate list L207.

The total can also be calculated by using the calculation expression “syou1+syou2+syou3,” and thus the user may input such a calculation expression. In this case as well, the user terminal 20 searches each function name, each field code, and each field name based on the input by the user, and displays the results of the search in the candidate list L207. The user can freely determine what kind of calculation expression to set.

As described above, the calculation expression setting system 1 calculates each function name, each field code, and each field name based on the input to the input form F202. The calculation expression setting system 1 displays, based on the search results, a candidate list L207 indicating not only a function name but also at least one of a field code or a field name on the user terminal 20. This allows the calculation expression setting system 1 to increase convenience of the user who inputs the calculation expression. Details of the at least one embodiment are now described.

### 3. Functions Implemented in Calculation Expression Setting System

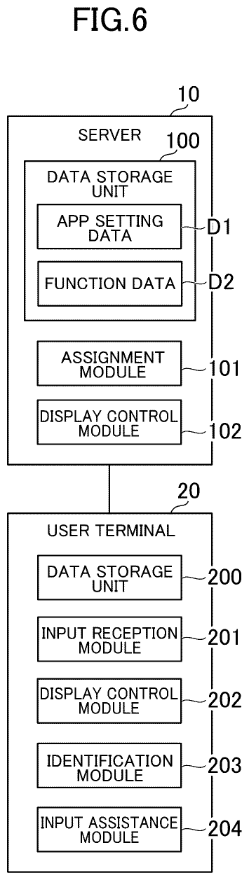

FIG. 6 is a diagram for illustrating an example of functions implemented in the calculation expression setting system 1.

### 3-1. Functions implemented in Server

For example, the server 10 includes a data storage unit 100, an assignment module 101, and a display control module 102. The data storage unit 100 is implemented by the storage unit 12. Each of the assignment module 101 and the display control module 102 is implemented by the control unit 11.

### Data Storage Unit

The data storage unit 100 stores various types of data in the groupware. For example, the data storage unit 100 stores app setting data D1 indicating an app setting and function data D2 indicating a function that can be a constituent element of the calculation expression.

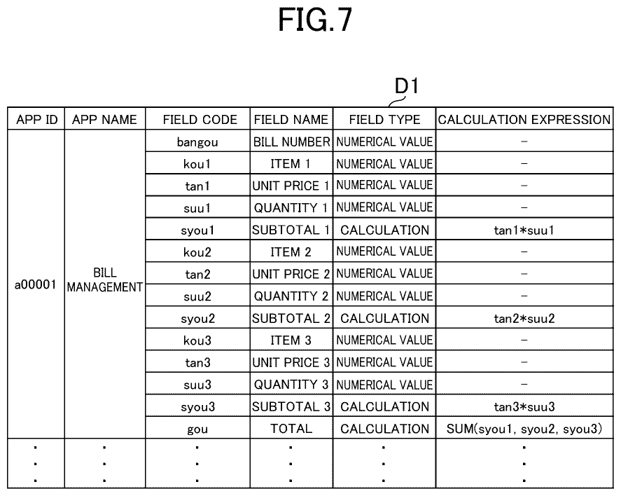

FIG. 7 is a table for showing an example of the app setting data D1. For example, the app setting data D1 stores data indicating each of an app ID, an app name, a field code, a field name, a field type, and a calculation expression. Any data may be stored in the app setting data D1. The data included in the app setting data D1 is not limited to the example of FIG. 7. For example, the app setting data DI may include record data indicating details of individual records, or data indicating whether or not a field is a selectable field (for example, a field such as a drop-down menu or a radio button field).

The app ID is an ID for the calculation expression setting system 1 to identify the app. The app name is the name of the app for display. The field type is the data type of the field. For example, the field type may be a numerical value, a calculation, a character string (single line), a character string (multiple lines), a date and time, a link, or a lookup. The user can specify any field type for the field. The field type may be displayed in the candidate list L207. The calculation expression may be set only in fields of some field types (for example, a calculation field type).

In the at least one embodiment, each field code and each field name is represented by a character, a number, another symbol, or a combination thereof. For example, the app setting data D1 stores data indicating each field code, field name, and field type for each field of the app. Data indicating the calculation expression is stored in the field in which the calculation expression is set. When the user changes a setting of the app, the server 10 updates the app setting data D1 to reflect the change designated by the user.

For example, a calculation expression to be set in a certain field is an expression having a value of at least one other field as an argument. The constituent elements of the calculation expression may be the same as the constituent elements used in publicly-known apps. For example, the constituent elements of the calculation expression may be an operator used in a calculation such as the four arithmetic operations, a function used in calculating a total value or the like, a field code that can be used by the calculation expression setting system 1 to identify the field, or another constituent element.

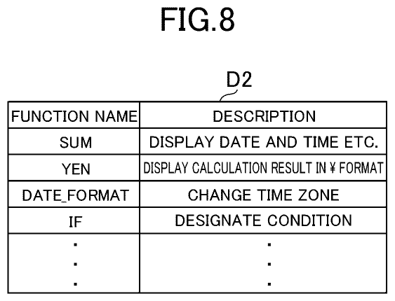

FIG. 8 is a table for showing an example of the function data D2. The function data D2 indicates a function that can be designated by the user as a calculation expression. For example, the function data D2 stores data indicating a function name and data indicating a description of the function. Any data may be stored in the function data D2. The data included in the function data D2 is not limited to the example shown in FIG. 8. For example, the function data D2 may include icon data indicating an icon of the function, data indicating an argument required by the user to designate the function, or other data.

The data storage unit 100 may store any data. The data stored in the data storage unit 100 is not limited to the app setting data D1 and the function data D2. For example, the data storage unit 100 may store data required for the display of screens such as the calculation expression setting screen SC2. The data storage unit 100 may store the data of icons displayed in the candidate list L207. The data storage unit 100 may also store other data such as a user ID and a password for users to log in to the groupware.

### Assignment Module

The assignment module 101 assigns the field name of the field to the field code used by the calculation expression setting system 1 to identify the field of the app. As used herein, the assignment module 101 assigning the field name to the field code means that the assignment module 101 associates the field code and the field name with each other. In other words, the assignment module 101 assigning the field name to the field code means enabling the assignment module 101 to search for the field name from the field code. In the at least one embodiment, the assignment module 101 assigns the field name to the field code by storing each field code and each field name in association with each other in the app setting data D1.

For example, the assignment module 101 assigns a field name designated by the user to a field code designated by the user. The user can designate any character, number, other symbol, or a combination thereof for each field code and each field name. In place of the user designating each field code and each field name, the assignment module 101 may automatically generate each field code and each field name. In this case, the programs for generating the field code and the field name are stored in the data storage unit 100. For example, the initial value of the field name may be the same as the field code. The initial value of the field code may be designated by the user. The server 10 may automatically generate those initial values.

### Display Control Module

The display control module 102 causes the user terminal 20 to display various screens of the groupware. For example, the display control module 102 transmits display data on the screen to be displayed to the user terminal 20, to thereby cause the user terminal 20 to display this screen. It is only required that the display data be data required by the user terminal 20 to display a certain screen on the display unit 25, and the display data may have any form. For example, when the user uses a browser, the display data may be HTML data. When the user uses not the browser, but a program specific to the groupware, data (for example, image data such as JPEG) having a form supported by this program is only required to be the display data.

In the at least one embodiment, the display data includes a script indicating processing to be executed by the user terminal 20 and data to be referenced by the script. For example, the display data of the calculation expression setting screen SC2 includes a script indicating the processing of each of an input reception module 201, a display control module 202, an identification module 203, and an input assistance module 204, which are described later, and data to be referenced by the processing of those modules (for example, the display data includes all or a part of the app setting data D1 and the function data D2). The processing of the input reception module 201, the display control module 202, the identification module 203, and the input assistance module 204 may be executed by groupware-specific programs stored in the data storage unit 200 of the user terminal 20 in place of a display data script.

### 3-2. Functions Implemented in User Terminal

For example, the user terminal 20 includes a data storage unit 200, the input reception module 201, the display control module 202, the identification module 203, and the input assistance module 204. The data storage unit 200 is implemented by the storage unit 22. Each of the input reception module 201, the display control module 202, identification module 203, and the input assistance module 204 is implemented by the control unit 21.

### Data Storage Unit

The data storage unit 200 stores data required for the user to use the groupware. For example, the data storage unit 200 stores the browser. The data storage unit 200 may store a program specific to the groupware. The data storage unit 200 may store display data of screens such as the calculation expression setting screen SC2.

### Input Reception Module

The input reception module 201 receives various types of input by the user. For example, the input reception module 201 receives types of input by the user on the calculation expression setting screen SC2. The input reception module 201 receives, in at least one of the input form F202 or the candidate list L207, input of characters, numbers, other symbols, or combinations thereof that can be constituent elements of the calculation expression. The input reception module 201 may also receive other input.

### Display Control Module

The display control module 202 displays various screens in the groupware on the display unit 25. The display control module 202 displays the screen in the groupware on the display unit 25 based on display data on the screen to be displayed, which is received from the server 10. In the at least one embodiment, a case in which the display control module 202 displays the various screens on a browser is taken as an example, but the display control module 202 may display the various screens on a program specific to groupware. There is now given description of mainly the calculation expression setting screen SC2 among the screens displayed by the display control module 202.

For example, the display control module 202 displays, based on input by the user on the calculation expression setting screen SC2 which receives input of the calculation expression to be set in the app, other information other than a function as a candidate on the calculation expression setting screen SC2. The input by the user can also be referred to as an operation by the user on the calculation expression setting screen SC2. The input by the user may be any input that can be performed by the user from the calculation expression setting screen SC2. For example, the input by the user may be the input of any character, number, other symbol, or a combination thereof. The input by the user may be selection of an image (for example, button B204) displayed on the calculation expression setting screen SC2. The input by the user may be the input of a specific key on the operating unit 24.

The other information is, among the constituent elements of the calculation expression, information indicating a constituent element other than a function. As referred to here, the information indicates what appears on the screen. In the examples of FIG. 4 and FIG. 5, among the items included in the candidate list L207, the items other than functions correspond to “other information.” In the at least one embodiment, the data required for displaying the other information is included in the display data of the calculation expression setting screen SC2. For example, the display data of the calculation expression setting screen SC2 includes, among the app setting data D1, data such as the field code of the app in which the calculation expression is to be set. The display data of the calculation expression setting screen SC2 also includes the function data D2. The display control module 202 controls the display of the candidate list L207, for example, based on those pieces of data.

In the at least one embodiment, the display control module 202 displays at least one of the field codes or the field names as the candidates on the calculation expression setting screen SC2. In the example of FIG. 4 and FIG. 5, the display control module 202 displays both the field codes and the field names as the candidates on the calculation expression setting screen SC2. The display control module 202 may display only any one of the field codes or the field names as candidates. For example, when the concept of only any one of the field codes or the field names exists, the display control module 202 displays only any one of the field codes or the field names as the candidates.

For example, the display control module 202 searches each field code and each field name based on the input by the user. That is, the display control module 202 executes a search by using the input by the user as a query and each field code and each field name as an index. The display control module 202 displays at least one of the field codes or the field names found in the search as the candidates on the calculation expression setting screen SC2. The display control module 202 may use any algorithm to execute the search. For example, the display control module 202 may execute the search based on a partial match, an exact match, a prefix match, a postfix match, or another algorithm. The search may or may not distinguish between uppercase letters and lowercase letters. The search may or may not distinguish between full-width and half-width characters. The display control module 202 may execute a search based on a fuzzy search.

For example, the display control module 202 may display each function as well as each piece of other information as the candidates on the calculation expression setting screen SC2. That is, the display control module 202 may display not only other information such as field codes and field names, but also functions as the candidates on the calculation expression setting screen SC2. In other words, the display control module 202 may display a calculation expression setting screen SC2 in which a mixture of functions and other information are listed as candidates.

For example, in addition to searching the field codes and field names, the display control module 202 also searches the function names based on the input by the user. That is, the display control module 202 executes a search by using the input by the user as a query and the function names as an index. Any of the algorithms described above may be used for the search in this case as well. When functions and other information are found in the search, the display control module 202 displays a candidate list L207 containing a mixture of functions and other information on the calculation expression setting screen SC2.

The other information displayed as candidates by the display control module 202 is not limited to the examples described in the at least one embodiment. The display control module 202 may display other information other than a field code or a field name as a candidate. For example, the display control module 202 may predict, based on the input by the user, an operator that the user is likely to input next, and display the operator as a candidate on the calculation expression setting screen SC2. The display control module 202 may predict a character, for example, that the user is likely to input based on the current input by the user and past input by the user, and display the predicted character as a candidate on the calculation expression setting screen SC2.

For example, the display control module 202 may search for candidates every time the user inputs something into the input form F202, and display the candidates found in the search on the calculation expression setting screen SC2. When no candidates are found, the candidate list L207 is not displayed on the calculation expression setting screen SC2. The display control module 202 may search for candidates and display the candidate list L207 on the calculation expression setting screen SC2 not only when a character or the like is input, but also when a character or the like input into the input form F202 is deleted.

For example, the display control module 202 may search for candidates and display the candidate list L207 on the calculation expression setting screen SC2 when a caret is located immediately after a specific symbol. The caret is a symbol indicating the position of the input by the user. In the examples of FIG. 3 to FIG. 5, the caret is a vertical bar that blinks on and off in the input form F202 when the user operates a cursor C to bring the input form F202 into focus.

For example, the display control module 202 may display at least one of the field codes or the field names of all the fields as candidates in the candidate list L207 when the caret is located immediately after a specific symbol. Further, when a line break is performed in the input form F202, the candidate list L207 may not be displayed on the calculation expression setting screen SC2 by the display control module 202 immediately after the line break.

For example, the display control module 202 may display a candidate list L207 which includes only a part of the candidates found in the search, in place of displaying a candidate list L207 which includes all the candidates found in the search. The display control module 202 may display the candidates on the calculation expression setting screen SC2 by using a method other than the candidate list L207. The display control module 202 may display only one of the plurality of candidates found in the search without using the candidate list L207. The display control module 202 may display the candidates in the input form F202 by using a placeholder function, for example, in place of the candidate list L207.

### Identification Module

The identification module 203 identifies the candidate selected by the user. The identification module 203 identifies the candidate selected by the user based on the input received by the input reception module 201. In the at least one embodiment, the identification module 203 identifies the candidate selected by the user based on the input to the candidate list L207. Even when the candidates are displayed by using a method other than the candidate list L207, the identification module 203 may identify the candidate based on input by the user.

### Input Assistance Module

The input assistance module 204 assists input of the calculation expression based on the candidate identified by the identification module 203. As used herein, the input assistance module 204 assisting input of the calculation expression refers to the input assistance module 204 automatically inputting the candidate selected by the user or a candidate corresponding to thereto one as a part of the constituent elements of the calculation expression. Automatically inputting can also be referred to as “supplementing.” For example, the input assistance module 204 automatically inputs the characters, the numbers, the other symbols, or the combination thereof indicated by the candidate into the input form F202.

For example, when the user selects a certain function, the input assistance module 204 automatically inputs the function name of the certain function into the input form F202. When the user selects a field code of a certain field, the input assistance module 204 automatically inputs the field code into the input form F202. When the user selects the field name of a certain field, because it is required to input the field code and not the field name of the field, the input assistance module 204 automatically inputs the field code of the field into the input form F202. Similarly, when other information is displayed as a candidate, the input assistance module 204 may perform the automatic input corresponding to the candidate selected by the user.

For example, the input assistance module 204 may assist input of the calculation expression by replacing a certain word at the position of the caret with a candidate. The input assistance module 204 may assist input of the calculation expression by adding a word at the position of the caret in place of replacing the word. When the left parenthesis (“(”) of a pair of parentheses (“( )”) of a function is originally present, the input assistance module 204 may replace the character string being input with the function name, and not automatically input the right parenthesis (“)”) of the pair of parentheses (“( )”) of the function. When the left parenthesis (“(”) of a pair of parentheses (“( )”) of a function is originally not present, the input assistance module 204 may replace a certain word at the position of the caret with the function name, and automatically input the pair of parentheses (“( )”) of the function. The caret may be moved to immediately after the left parenthesis (“(”) of the pair of parentheses (“( )”) of the function.

### 4. Processing Executed by Calculation Expression Setting

System

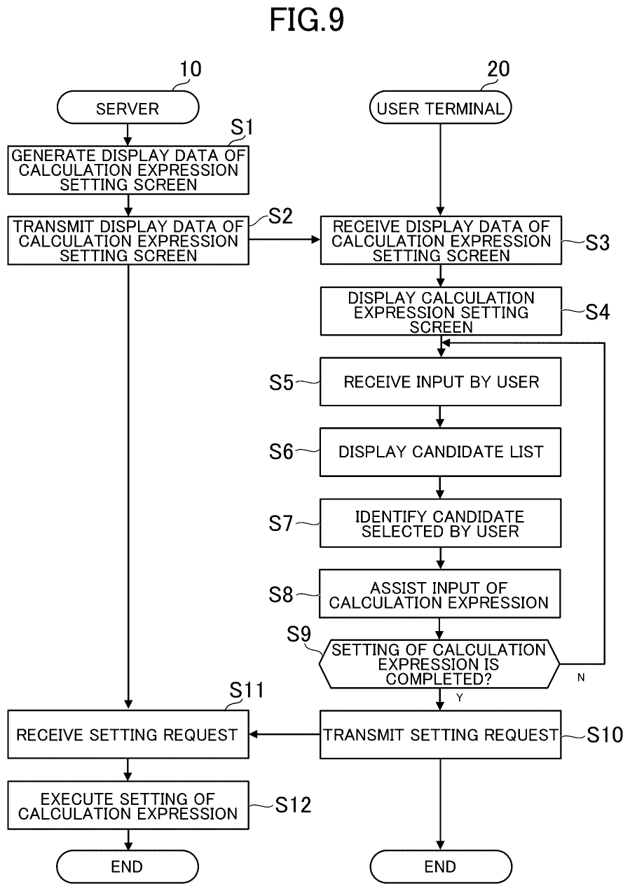

FIG. 9 is a flow chart for illustrating an example of processing executed by the calculation expression setting system 1. The processing of FIG. 9 is executed by the control units 11 and 21 executing the programs stored in the storage units 12 and 22, respectively. In the example of FIG. 9, processing executed when the user has selected the app and the field in which a calculation expression is to be set is illustrated. Each processing step illustrated in FIG. 9 is also an example of processing included in the calculation expression setting method according to the present disclosure.

As illustrated in FIG. 9, the server 10 generates the display data of the calculation expression setting screen SC2 based on the app and the field selected by the user as a calculation expression setting target (Step S1). In Step S1, the server 10 refers to the app setting data D1, and acquires the data of each field name and each field type of each field of the app selected by the user. The server 10 generates display data including the output data and the function data D2. It is assumed that data indicating a script included in the display data is stored in the storage unit 12 in advance.

The server 10 transmits display data of the calculation expression setting screen SC2 to the user terminal 20 (Step S2). The user terminal 20 receives the display data of the calculation expression setting screen SC2 from the server 10 (Step S3). For example, the user terminal 20 displays the calculation expression setting screen SC2 on the display unit 25 based on the display data (Step S4). The display data of the calculation expression setting screen SC2 includes data required for the processing steps of Step S4 to Step S10. Thus, the user terminal 20 can execute the processing steps of Step S4 to Step S10 without communicating to and from the server 10.

The processing executed when the user focuses the input form F202 and inputs a character, for example, is now described. The user terminal 20 receives input by the user in the input form F202 (Step S5). The user terminal 20 displays the candidate list L207 on the calculation expression setting screen SC2 based on the input by the user (Step S6). In Step S6, the user terminal 20 searches each function name, each field code, and each field name based on the input by the user. The user terminal 20 displays a candidate list L207 indicating the candidates found in the search on the calculation expression setting screen SC2. When no candidates are found in the search, the user terminal 20 does not display the candidate list L207 on the calculation expression setting screen SC2.

The user terminal 20 identifies the candidate selected by the user (Step S7). The user terminal 20 assists input of the calculation expression by automatically inputting the characters, for example, of the candidate selected by the user into the input form F202 (Step S8). When the user does not select a candidate, the processing steps of Step S7 and Step S8 are not executed. The user terminal 20 determines whether or not to complete the setting of the calculation expression (Step S9). In Step S9, the user terminal 20 determines whether or not the user has selected the button B205. When the user selects the button B206, the processing ends without executing the processing steps of Step S10 and the subsequent steps.

In Step S9, when it is not determined to complete the calculation expression setting (“N” in Step S9), the process returns to Step S5. When it is determined to complete the calculation expression setting (“Y” in Step S9), the user terminal 20 transmits a setting request for setting the calculation expression to the server 10 (Step S10). The setting request includes data indicating the calculation expression input into the input form F202. The server 10 receives the calculation expression setting request from the user terminal 20 (Step S11). The server 10 executes the setting of the calculation expression (Step S12), and this processing ends. In Step S12, the server 10 updates the app setting data D1 so that the calculation expression is set in the field of the app designated by the user.

In the calculation expression setting system 1 of the at least one embodiment, information other than functions is displayed as the candidates on the calculation expression setting screen SC2 based on input by the user on the calculation expression setting screen SC2. The calculation expression setting system 1 identifies the candidate selected by the user. The calculation expression setting system 1 assists input of the calculation expression based on the identified candidate. As a result, the user can proceed with inputting the calculation expression while selecting candidates, and thus the calculation expression setting system 1 can reduce the operational burden on the user and increase convenience of the user. For example, even when the user does not remember all of the other information such as a field code, candidates can be displayed as long as the user remembers only a part of the information, and thus the calculation expression setting system 1 can increase convenience of the user in this aspect as well.

Further, the calculation expression setting system 1 assigns the field name of the field to the field code. As a result, the calculation expression setting system 1 can increase convenience of the user by reducing the operational burden on the user who inputs the calculation expression when a field is identified based on the field code and the field name. The calculation expression setting system 1 makes it easier for the user to manage fields by managing each field based on a field code different from the field name displayed on the app screen SC1.

Further, the calculation expression setting system 1 displays at least one of a field code or a field name as a candidate on the calculation expression setting screen SC2. As a result, the calculation expression setting system 1 can increase the convenience of the user who designates a field as a constituent element of the calculation expression. For example, in the calculation expression setting system 1, the user is not required to input all of the field codes when displaying field codes as candidates. In the calculation expression setting system 1, when displaying a field name as a candidate, the field name can be displayed as a candidate even when the user forgets the field code, as long as the user remembers even a part of the field name.

Further, the calculation expression setting system 1 searches each field code and each field name, and displays at least one of the field codes or the field names found in the search as candidates on the calculation expression setting screen SC2. As a result, the calculation expression setting system 1 can display the field name as a candidate even when the field code does not match the input by the user. The calculation expression setting system 1 can display the field code as a candidate even when the field name does not match the input by the user. The user can search for a desired field as long as the user remembers any one of the field code or the field name, and thus the calculation expression setting system 1 can further increase convenience of the user.

Further, the calculation expression setting system 1 displays each function and each piece of other information as the candidates on the calculation expression setting screen SC2. As a result, the calculation expression setting system 1 can increase convenience of the user who inputs not only other information such as field codes but also functions.

### 5. Modification Examples

The present disclosure is not limited to the example of the at least one embodiment. The present disclosure can be modified without departing from the purport of the present disclosure.

### 5-1. Modification Example 1

For example, the display control module 202 may display each of a plurality of pieces of other information which are of a different type from each other as the candidates on the calculation expression setting screen SC2. The type of the other information is the content of the other information. The field codes and the field names described in the at least one embodiment are also different from each other in terms of the content of the information, and thus the field codes and the field names are examples of a plurality of pieces of the other information which are of a different type from each other. The plurality of pieces of the other information which are of a different type from each other are not limited to field codes and field names. For example, the other information may be an operator, a numerical value indicating the year, month, and day, a numerical value that can be used as some sort of threshold value, a character input by the user in the past, or a character often used in calculation expressions.

The display control module 202 in Modification Example 1 may display each of the plurality of pieces of the other information which are of a different type from each other, which are pieces of other information that can be a constituent element of the calculation expression, as candidates. For example, the display control module 202 may display each field code, each field name, and each operator as the candidates. The display control module 202 may display an operator that matches the input by the user as a candidate, or may display an operator that is estimated to be input next by the user as a candidate. Data required for displaying the other information other than a field code or a field name is included in the display data of the calculation expression setting screen SC2.

For example, when the app name of another app is designatable by the user as a constituent element of the calculation expression, the display control module 202 may display the app name as a candidate. The display control module 202 may display the app name that matches the input by the user as a candidate, or may display the app name that is estimated to be input next by the user as a candidate. The display control module 202 may display two or more of the field code, the field name, the operator, and the app name as candidates. The display control module 202 may display other information that can be a constituent element of the calculation a expression as candidate.

The calculation expression setting system 1 of Modification Example 1 displays each of a plurality of pieces of other information which are of a different type from each other as the candidates on the calculation expression setting screen SC2. As a result, the calculation expression setting system 1 can effectively reduce the operational burden on the user who inputs a calculation expression to be set in an app. For example, even when the user is required to include various constituent elements in the calculation expression, the calculation expression setting system 1 can display those constituent element candidates on the calculation expression setting screen SC2.

### 5-2. Modification Example 2

For example, when the user selects the button B203 indicating insertion of a function, the display control module 202 may display a function list indicating a list of the functions that are designatable by the user on the calculation expression setting screen SC2. Data required for displaying the function list is included in the display data of the calculation expression setting screen SC2. The identification module 203 identifies the function selected by the user from the function list. The input assistance module 204 assists input of the calculation expression based on the function identified by the identification module 203.

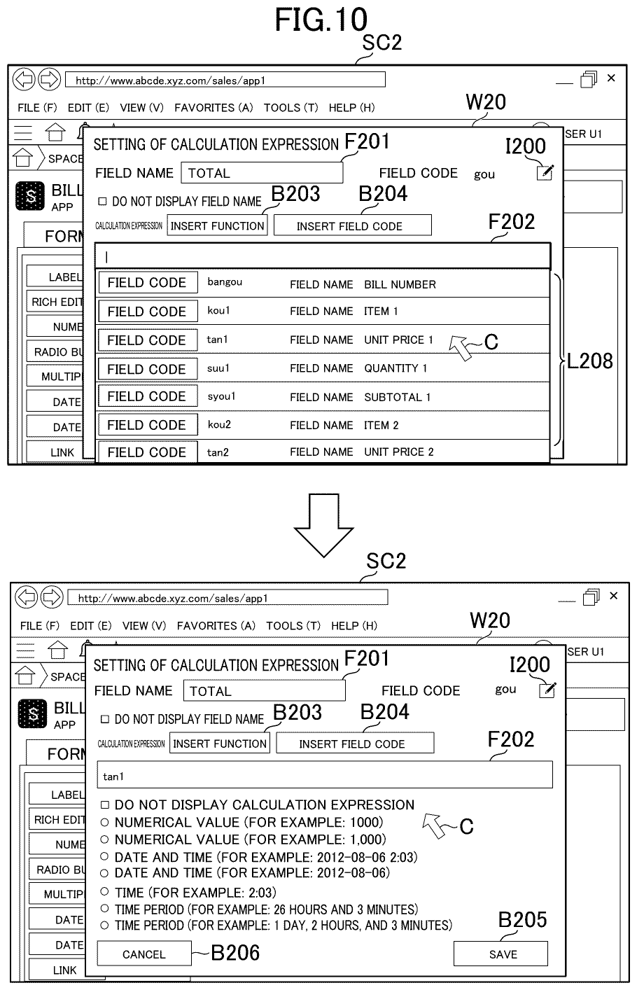

FIG. 10 is a view for illustrating an example of the calculation expression setting screen SC2 displayed when the button B204 indicating insertion of a field code is selected. The display control module 202 in Modification Example 2 displays a field list L208 which includes at least one of the field code or the field name of each of a plurality of fields as the candidates on the calculation expression setting screen SC2. In the example of FIG. 10, the field list L208 includes both field codes and field names as candidates, but the field list L208 may include only any one of field codes or field names.

In Modification Example 2, it is assumed that the field list data required to display the field list L208 is included in the display data of the calculation expression setting screen SC2. The field list data may be a part of the app setting data D1, or may be data different from the app setting data D1. The display control module 202 displays the field list L208 on the calculation expression setting screen SC2 based on the field list included in the display data of the calculation expression setting screen SC2.

The identification module 203 in Modification Example 2 identifies the candidate selected by the user from the field list L208. The identification module 203 identifies the candidate selected by the user based on the input received by the input reception module 201. The input assistance module 204 assists input of the calculation expression based on the candidate selected by the user from the field list L208. The processing by which the input assistance module 204 assists input of the calculation expression is as described in the at least one embodiment.

The calculation expression setting system 1 of Modification Example 2 displays a field list including at least one of the field code or the field name of each of a plurality of fields as the candidates on the calculation expression setting screen SC2. The calculation expression setting system 1 identifies the candidate selected by the user from the field list. As a result, the calculation expression setting system 1 can allow the user to select a function from the field list L208, thereby increasing convenience of the user. For example, even when the user has not input anything in the input form F202, by selecting the button B204, the user can select a field to be included in the calculation expression.

### 5-3. Modification Example 3

For example, depending on the function, the arguments that are designatable by the user may be limited. In this case, when a candidate that is not designatable as an argument by the user is displayed, the user may select that candidate by mistake. In view of this, the user terminal 20 in Modification Example 3 narrows down the candidates so that candidates that are not designatable as an argument by the user are not displayed. In Modification Example 3, it is assumed that the display data of the calculation expression setting screen SC2 includes data indicating the field type of each field of the app in which the calculation expression is to be set.

The display control module 202 in Modification Example 3 displays candidates on the calculation expression setting screen SC2 based on a function corresponding to the position of the caret on the calculation expression setting screen SC2. For example, the data storage unit 200 stores caret position data indicating the position of the caret. The user terminal 20 updates the caret position data so that the caret moves based on an operation by the user. It is assumed that a relationship between the position of the caret and candidate display targets, which are the candidates to be displayed on the calculation expression setting screen SC2, is stored in the data storage unit 200. In Modification Example 3, the display data of the calculation expression setting screen SC2 includes candidate narrowing data for the display control module 202 to narrow down the candidate display targets. The candidate narrowing data is also stored in the data storage unit 100 of the server 10.

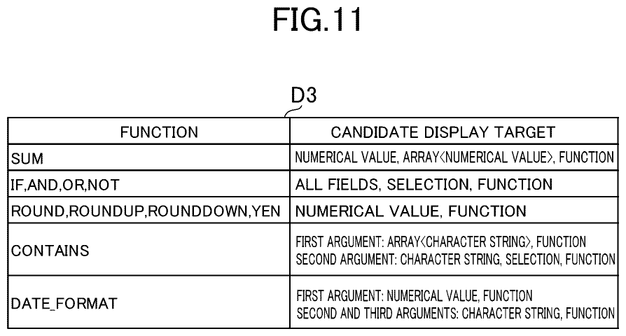

FIG. 11 is a table for showing an example of the candidate narrowing data. For example, the display control module 202 narrows down the candidates of the candidate display targets associated with a function corresponding to the position of the caret based on candidate narrowing data D3 from among the plurality of candidates found in a search performed by using the same method as in the at least one embodiment. The function corresponding to the position of the caret is the function which includes the caret or the function closest to the caret (the function immediately before the caret). The display control module 202 displays the candidates narrowed down from the plurality of candidates found in the search in the candidate list L207.

For example, the display control module 202 may display field information on a field as a candidate on the calculation expression setting screen SC2 based o on the function corresponding to the position of the caret and the field type of the field in the database. Field information is information that allows a user to identify a field. For example, the field information is at least one of a field code or a field name. In the example of FIG. 11, for the function “SUM,” the candidate narrowing data D3 indicates a numerical value field type, a field having an array of numerical value type expressions, and a function as candidate display targets. When the function corresponding to the position of the caret is “SUM,” the display control module 202 displays a numerical value field type, a field having an array of numerical value type expressions, and a function as candidates in the candidate list L207 from among the plurality of candidates found in the search.

In the example of FIG. 11, for each of the function “IF,” the function “AND,” the function “OR,” and the function “NOT”, all field types, a field having a selection expression, and a function are shown in the candidate narrowing data D3. When the function corresponding to the position of the caret is one of those four functions, the display control module 202 displays all field types, fields having a selection expression, and functions as candidates in the candidate list L207 from among the plurality of candidates found in the search.

In the example of FIG. 11, for each of the function “ROUND,” the function “ROUNDUP,” the function “ROUNDDOWN,” and the function “YEN”, field types having a numerical value and a function are shown in the candidate narrowing data D3. When the function corresponding to the position of the caret is one of those four functions, the display control module 202 displays field types having a numerical value and functions as candidates in the candidate list L207 from among the plurality of candidates found in the search.

For example, when a plurality of arguments are designatable by the user for the function corresponding to the position of the caret, the display control module 202 may display, among the plurality of arguments, candidates on the calculation expression setting screen SC2 based on an argument corresponding to the position of the caret. The argument corresponding to the position of the caret is the order of the arguments within the function. The argument corresponding to the position of the caret may be identified by the number of commas within the parentheses of the function, for example. The display control module 202 refers to the candidate narrowing data D3, and narrows down the plurality of candidates found in the search based on the function and the argument corresponding to the position of the caret.

In the example of FIG. 11, the function “CONTAINS” has two arguments designated. The function “DATE_FORMAT” has three arguments designated. There may be functions in which four or more arguments are designated. It is assumed that data indicating how many arguments are required for each function is included in the display data of the calculation expression setting screen SC2. The display control module 202 may identify the number of arguments of the function corresponding to the position of the caret based on that data.

In the example of FIG. 11, the function “CONTAINS” has, in a first argument, a field having an array of character string type expressions and a function shown in the candidate narrowing data D3. In a second argument, a field having a character string type expression, a field having a selection expression, and a function are shown in the candidate narrowing data D3. When the function corresponding to the position of the caret is “CONTAINS” and the argument corresponding to the position of the caret is the first argument, among the plurality of candidates found in the search, the display control module 202 displays the field having an array of character string type expressions and the function as candidates in the candidate list L207. When the function corresponding to the position of the caret is “CONTAINS” and the argument corresponding to the position of the caret is the second argument, among the plurality of candidates found in the search, the display control module 202 displays the field having a character string type expression, the field having a selection expression, and the function as candidates in the candidate list L207.

In the example of FIG. 11, the function “DATE_FORMAT” has, in a first argument, a field having numerical value type expressions and a function shown in the candidate narrowing data D3. In each of a second argument and a third argument, a field having a character string type expression, and a function are shown in the candidate narrowing data D3. When the function corresponding to the position of the caret is “DATE_FORMAT” and the argument corresponding to the position of the caret is the first argument, among the plurality of candidates found in the search, the display control module 202 displays the field having numerical value type expressions and the function as candidates in the candidate list L207. When the function corresponding to the position of the caret is “DATE_FORMAT” and the argument corresponding to the position of the caret is the second argument or the third argument, among the plurality of candidates found in the search, the display control module 202 displays the field having a character string type expression and the function as candidates in the candidate list L207.

The calculation expression setting system 1 of Modification Example 3 displays candidates on the calculation expression setting screen SC2 based on the function corresponding to the position of the caret on the calculation expression setting screen SC2. The calculation expression setting system 1 can prevent the user from mistakenly designating a constituent element that is not designatable within the function, and thus can further increase convenience of the user.

Further, the calculation expression setting system 1 displays field information on fields as the candidates on the calculation expression setting screen SC2 based on the function corresponding to the position of the caret and the field type of the fields of the database. As a result, the calculation expression setting system 1 can prevent the user from mistakenly designating a field having a field type that is not designatable within the function, and thus can further increase convenience of the user.

In addition, when a plurality of arguments are designatable by the user in relation to the function corresponding to the position of the caret, the calculation expression setting system 1 displays, among the plurality of arguments, the candidates on the calculation expression setting screen SC2 based on the argument corresponding to the position of the caret. As a result, the calculation expression setting system 1 can prevent the user from mistakenly designating a constituent element that is not designatable by a specific argument within the function, and thus can further increase convenience of the user.

### 5-4. Other Modification Examples

For example, the calculation expression setting system 1 may combine Modification Example 1 to Modification Example 3.

For example, the database in which the calculation expression is to be set is not limited to a groupware app. The calculation expression setting system 1 may set the calculation expression in a database other than that of an app. For example, the calculation expression setting system 1 may set, among the databases of a groupware, a calculation expression in a database other than that of an app. The calculation expression setting system 1 may set a calculation expression in the database of a task support system that is not classified as groupware. The calculation expression setting system 1 may set a calculation expression in a database other than that of a task support system. The calculation expression setting system 1 may set a calculation expression in a database in which data other than that for task support is stored. For example, the database may be a relational database, a network database, a NoSQL database, or another type of database.

For example, when the user places a cursor C on a constituent element of a calculation expression input in the input form F202, the display control module 202 may display an image showing a supplementary description of the constituent element indicated by the cursor C on the calculation expression setting screen SC2. In this case, it is assumed that the data for displaying the image is included in the display data of the calculation expression setting screen SC2. The display control module 202 identifies which constituent element is being pointed to based on the position of the cursor C. The display control module 202 displays the image showing a supplementary description of the identified constituent element on the calculation expression setting screen SC2. The supplemental description may relate to a function, a field code, or another constituent element.

For example, the functions described as being implemented by the user terminal 20 may be implemented by the server 10. In this case, it is only required that the functions similar to those of the user terminal 20 be implemented by being executed by a program of the server 10. For example, the display control module 102 may have the functions similar to those of the display control module 202. In this case, the user terminal 20 transmits data indicating input content to the server 10 every time the user performs some sort of input. The display control module 202 generates data for the candidate list L207 based on the data indicating the input content, and displays the candidate list L207 on the user terminal 20.

For example, each of the identification module 203 and the input assistance module 204 may be implemented by the server 10. That is, the main functions of input assistance for the calculation expression may be implemented by the server 10 in place of the user terminal 20. Conversely, the functions described as being implemented by the server 10 may be implemented by the user terminal 20. At least one of the functions described as being implemented by the server 10 or the functions described as being implemented by the user terminal 20 may be distributed to a plurality of computers.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A calculation expression setting system, comprising at least one processor, the at least one processor being configured to:
display, based on input by a user on a calculation expression setting screen for receiving input of a calculation expression to be set in a database, pieces of other information other than a function as candidates on the calculation expression setting screen;
identify a candidate selected by the user; and
assist input of the calculation expression based on the identified candidate.

2. The calculation expression setting system according to claim 1, wherein the at least one processor is configured to assign, to a field code for the calculation expression setting system to identify a field of the database, a field name of the field.

3. The calculation expression setting system according to claim 1, wherein the at least one processor is configured to display each of a plurality of pieces of the other information which are of a different type from each other as the candidates on the calculation expression setting screen.

4. The calculation expression setting system according to claim 2, wherein the at least one processor is configured to display at least one of the field code or the field name as the candidates on the calculation expression setting screen.

5. The calculation expression setting system according to claim 4, wherein the at least one processor is configured to search each of the field code and the field name, and to display at least one of the field code or the field name found in the search as the candidates on the calculation expression setting screen.

6. The calculation expression setting system according to claim 4, wherein the at least one processor is configured to:
display a field list including at least one of the field code or the field name of each of a plurality of the fields as the candidates on the calculation expression setting screen; and
identify a candidate selected by the user from the field list.

7. The calculation expression setting system according to claim 1, wherein the at least one processor is configured to display the function and each of the pieces of other information as the candidates on the calculation expression setting screen.

8. The calculation expression setting system according to claim 1, wherein the at least one processor is configured to display the candidates on the calculation expression setting screen based on the function corresponding to a position of a caret on the calculation expression setting screen.

9. The calculation expression setting system according to claim 8, wherein the at least one processor is configured to display, based on the function corresponding to the position of the caret and a field type of fields of the database, field information on the fields as the candidates on the calculation expression setting screen.

10. The calculation expression setting system according to claim 8, wherein the at least one processor is configured to display, when a plurality of arguments are designatable by the user for the function corresponding to the position of the caret, the candidates on the calculation expression setting screen based on, among the plurality of arguments, an argument corresponding to the position of the caret.

11. A calculation expression setting method, comprising:
displaying, based on input by a user on a calculation expression setting screen for receiving input of a calculation expression to be set in a database, pieces of other information other than a function as candidates on the calculation expression setting screen;
identifying a candidate selected by the user; and
assisting input of the calculation expression based on the identified candidate.

12. A non-transitory information storage medium having stored thereon a program for causing a computer to:
display, based on input by a user on a calculation expression setting screen for receiving input of a calculation expression to be set in a database, pieces of other information other than a function as candidates on the calculation expression setting screen;
identify a candidate selected by the user; and
assist input of the calculation expression based on the identified candidate.
